(19) United States
(12) Patent Application Publication
(10) Pub. No.: US 2004/0181951 A1
(43) Pub. Date: Sep. 23, 2004

(54) Chain saw safety system

(76) Inventor: Edward R. Wittke, Warwick, NY (US)

Correspondence Address: Joseph B. Taphorn, 8 Scenic Dr., HAGAN Farms, Poughkeepsie, NY, 12603, US

(21) Appl. No.: 10/390,583

(22) Filed: Mar. 17, 2003

(51) Int. Cl. B26B 1/00; B23D 57/02

(52) U.S. Cl. 30/382

(57) ABSTRACT

A system effectuates increased cutting device safety through rapid detection of abrupt motion of the device, and/or the proximity of the device cutting elements in relation to its operator. An adaptive signal processor receives signals from accelerometers (i.e. motion sensors) and/or proximity sensors, and adjusts an electro-mechanical interface with the cutting device drive and/or power mechanism. Sensors resident on the user may be spatially dispersed to protect multiple areas of potential interaction between device and operator. The adaptive signal processor receives and processes the sensor signals, determines motion and proximity measurements, compares the measurements to predetermined and set thresholds, and effectuates device interruption should thresholds be reached. The signal processor contains an adaptive signal processing algorithm which accounts for noise and invalid sensor measurements such as those made due to some external object physically disrupting proximity sensor-pair measurements.

### FIELD OF THE INVENTION

This invention relates to the field of power cutting devices, and more particularly to chain saws utilizing sensor based measurement systems to enhance the safety of their operation.

### BACKGROUND OF THE INVENTION

A chain saw is a portable power tool having a bar mounting a motor, usually a gasoline engine, and a driven endless chain bearing cutting teeth. The chain saw is a very effective and efficient device for cutting timber. It use has grown from principally a commercial device to a somewhat standard everyday garage tool. Chain saws today are used as cutting tools for a variety of purposes, situations, and environments—from tree cutting to statues carving. Behind their usefulness lurks a potentially-lethal side effect. Talk to any experienced tree service person, and he usually can relate some accident whether personal or not that he has encountered over the years.

Inherent in the expansion of its use from a commercial to household device, is a disproportionately large increase in the number of non-professional users—in other words everyday people. These people typically purchase the device at a local store, have very limited experience, and only use the device occasionally. The specialty chainsaw stores do take the time to instruct buyers on safety measures and precautions; however the lion's share of saws are purchased in the large discount stores. Even if the user does receive proper training, the infrequency in which he typically uses the device precludes him from maintaining the proper awareness and user skills.

The Portable Power Equipment Manufacturers Association recently stated that industry shipments of gasoline-powered chainsaws in the year 2000 were something on the order of 2,126,680 units.

By their very nature, chain saws are very dangerous devices that cause some thousands of injuries and deaths each year. The revolving chain contains a multitude of small individual cutting teeth that easily cause unimaginable damage to the unfortunate chain saw user. Kickback, a very sudden and violent non-user initiated movement of the saw, occurs often in practice. In this situation the saw surges in a particular direction with an extremely high acceleration and velocity which often precludes the user from having sufficient time to take proper action.

The aforementioned Association also reported that chainsaw kickback can occur in less than 0.3 seconds, whereas measured human reaction time is only 0.75 seconds. The time difference of course leaves the unfortunate operator at an extreme disadvantage. Records also show that most injuries occur during limbing operations, that is, during the removal of limbs from the main trunk of the tree.

There currently exist and have for some time, a number of apparatuses to increase the safety of operation of these chain saws, such as chain brakes, bar tip guides, reduced kickback guide bars, and low or reduced kickback saw chains; however statistics still reveal an inherent ineffectiveness of these solutions. Of course money is always a factor, and any additional component beyond those necessary to perform the desired operation adds further cost to the unit.

There are many types of saw chains on the market, ranging from consumer chains to professional chains; they vary in ways such as cutting teeth shape and depth gauges. Consumer chains tend to be designed to minimize kickback at the expense of performance, whereas professional chains have increased performance but less kickback protection. Chainsaws are typically classified into three groups: lightweight (8-13 inches typically), midweight (14 to 18 inches), and the professionally-oriented heavyweight (over 18 inches). Two types of commonly available chain saw bars are laminate and solid bars.

At full motor throttle, chains can move upwards of 45 MPH (miles per hour), which equates in some cases to 600 teeth moving past a single spot per second. It is also commonly recommended to wear ear protection, as common saws produce in excess of 95 decibels of noise.

The U.S. Consumer Product Safety Commission stated back in 1979 that approximately 50,000 people required hospital treatment for injuries associated with chain saws. They went on to state that most of these accidents were caused by the operator coming into contact with moving chain saw teeth. Injuries from a chain saw are usually serious because they leave a jagged cut.

The Davis Garvin Agency, an insurance underwriter specializing in loggers insurance, in 1989 reported the average chain saw injury requires 110 stitches and the average medical cost was $5,600.00. By today's standards this might easily equate to something closer to 12,000 dollars. There are 69,000 loggers in the U. S. alone.

Standard on many newer saws is an automatic engine cutoff mechanism activated by depression of a secondary physical lever attached to the saw. (See FIG. 3 of the drawings.) As the saw rotates backwards, the users arm causes the lever to be depressed and the engine to be cut off. This mechanism while useful does not totally eliminate nor address the dangers associated with all of the situations and scenarios in which chain saw might be used. Thus while the mechanism does undoubtedly increase the safety of the saw, it does not sufficiently protect the user against all of the possible dangerous conditions which may and do commonly occur. For example, a user may have his hands positioned in such a way that they do not engage the protective bar as the chain saw swings back at them. Also a user occasionally will use a single arm to reach a cutting target.

### PRIOR Art

Numerous U. S. patents describe purely mechanical, “clothing”, like measures to enhance the protection of cutting device operators.

Stoner in U.S. Pat. No. 5,987,778 describe protective footwear and lower leg covering which may help in the prevention of injury when operating chain saws.

Foy and Tejani in U.S. Pat. No. 5,876,834 utilize a sacrificial fabric structure in their protective chain saw chaps design to offer protection to operators.

### SUMMARY OF THE INVENTION

Accordingly, it is an object of the invention to improve the safety of chain saws and the like.

A more specific object of the invention to prevent deaths, injuries and disfigurements from being incurred during the use of chain saws and the like.

Another object of the invention is to provide a chain saw whose cutting action is stopped whenever the saw is moved abruptly in the direction of its user.

Still another object of the invention is to provide a chain saw whose cutting action is stopped whenever the cutting teeth of the saw come close to body parts of the user.

Yet another object of the invention is to provide a safer chain saw whose cutting effectiveness is not impaired.

A still further object of the invention is to provide a safer chain saw that is easy of manufacture and of little additional cost.

Some of the objects of the invention are achieved by an integrated, automatic, extremely-quick apparatus and method of stopping the cutting action of the chain saw in the event that the saw makes a sudden moment towards its user. To this end an accelerometer is mounted near the free end of the chain-saw bar about which the endless chain moves (usually an integrated cog-wheel). Additional accelerometers may be mounted on other parts of the saw to monitor closely sudden movements of those parts. A signal processor mounted on the chain saw receives the accelerometer(s) signals of abrupt movements and signals an electromechanical device to apply the proper electrical and/or mechanical measures to discontinue movement of the cutting endless chain.

A feature of the invention is that the above mentioned method and apparatus are completely automated—the user does not need to do anything to activate the safety mechanism.

Other of the objects of the invention are achieved by an integrated, automatic, extremely-quick apparatus and method of stopping the cutting action of the chain saw in the event that the saw the cutting arm gets within predetermined hazardous distances from body parts of the user. To this end proximity sensors are mounted near the free or front and the rear ends of the endless-chain encircled portions of the chain-saw bar, and resident sensors or emitters on the exposed, forward body parts of the user, to very quickly and accurately determine the distance of the cutting chain from those forward or exposed physical parts of the user. As the proximity sensors on the saw get within one or more of the predetermined hazardous distances to various forward parts of the user, they emit signals to discontinue movement of the cutting endless chain. A signal processor mounted on the chain saw receives the proximity signals of hazardous closeness(s) and signals an electromechanical device to apply the proper electrical and/or mechanical measures to discontinue movement of the cutting endless chain. Discontinuance of the cutting endless-chain movement may be by circuit interruption, de-clutching and/or braking operations.

The safety action of the hazardous distance safety system may be enhanced by electrically interconnecting (as by hard wiring or wireless) the array of proximity sensors resident on the user's or operator's exterior surface, with the chain saw computer processing unit. Thus should a chain saw mounted proximity sensor fail to send the danger signals, the particular body resident one would.

Accordingly, it is an object of the invention to provide a means by which possibly dangerous movement of a cutting device can be detected and subsequently used to alter the operation of the device to enhance the safety of an operator.

A further object of the invention to provide a means by which the distance between a cutting device and respective operator can be monitored and utilized to ensure the safety of said operator.

The objects of the invention are achieved by the use of a signal processor which receives the sensor signals, determines if thresholds are exceeded and if so signals an electromechanical device to apply the proper electrical and/or mechanical measure to alter the operation of the cutting device.

Thus the device and method enables the detection of dangerous movement and proximity of cutting devices relative to the operator and transmission a signal to the device itself.

### BRIEF DESCRIPTION OF DRAWINGS OF PREFERRED EMBODIMENTS OF THE INVENTION

These and other objects, features, and advantages of the invention will become apparent from a reading of the following descriptions of preferred embodiments of the invention, when considered with the attached drawings wherein:

FIG. 1 is diagram from the U. S. Consumer Protection Safety Commission showing 1999 chain saw injury statistics in relation to locations on the body of a user;

FIG. 2 is a diagrammatic display of common chain saw components;

FIG. 3 is a pictorial representation of “Kick back”—a common industry occurrence

FIG. 4 is a diagram of chain saw related accident;

FIG. 5 is a diagram of the safety cutoff bar activation;

FIG. 6 is a diagram representing cutoff bar engagement by means of the operator's arm;

FIG. 7 is a diagram of a sensor placement;

FIG. 8 is a diagram of slowing a chain saw mounted proximity sensor in relation to several user-body resident proximity sensors and critical distances which are looked-for between them;

FIG. 9 is an diagrammatic overview of a two-accelerometer bearing chain saw, which send out signals in response to abrupt movement of the respective ends of the saw:

FIG. 10 is a diagrammatic representation of a chain saw having an accelerometer at each end and a proximity sensor at the free end and electrically interconnected with a central processing unit (CPU), and of a user holding the chain saw and whose forward body parts bear proximity sensors also electrically interconnected to the central processing unit;

FIG. 11 is a composite view depicting sensor size considerations, and includes a diagrammatic top view of the chain saw bar and an endless chain thereon, an exploded view of a portion thereof, and a side view of the free end portion thereof;

FIG. 12 is a diagrammatic top view of the chain saw bar showing the side mounting thereon of two sensors, namely an accelerometer sensor and a proximity sensor, and an exploded view showing the physical encapsulation of proximity sensor designed to prevent head-on engagement with an obstacle and consequential dislodgment from the chain saw bar;

FIG. 13 is a diagrammatic top view of the chain saw bar or cutting arm showing the internal mounting therein of two sensors, namely an accelerometer sensor and a proximity sensor; and a partial side view of the same bar showing that the sensors are not visible nor externally exposed, that is the sensors are mounted within the cutting arm itself;

FIG. 14 is a schematic diagram showing the functional interfacing of the key components of the new safe chain saw;

FIG. 15 relates how movement of any of a number of chain saw mounted accelerometers beyond its predetermined velocity/acceleration thresholds, signals stopping the chain saw; and

FIG. 16 relates how movement of any of a number of chain-saw-mounted proximity sensors within its predetermined distance to the operator threshold, signals stopping the chain saw via a signal processor.

### DETAILED DESCRIPTION OF INVENTION PREFERRED EMBODIMENTS

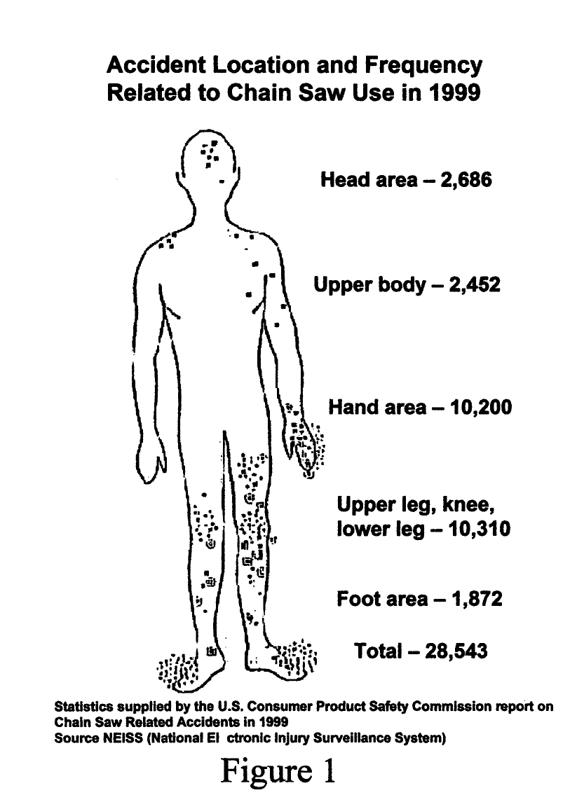

Referring now particularly to the drawings, FIG. 1 shows a summary of the 1999 US Consumer Protection Safety Commission report of 28,543 accidents related to chain saw use in the United States. It is important to note the location of injury on the body and associated frequency: 2,686 to the head, 2,452 to the upper body, 10,200 to the hands, upper leg-knee-lower leg 10,310, and 1,872 to the foot area. Though the data reflects that chain saws cause injuries throughout the body, more than 36% of them were injuries to the legs and knees.

Protective clothing, commonly called chaps, has been available, but its effectiveness is limited and doesn't do what an operator optimally wants—preventing the spinning chain from touching his or her body in the first place.

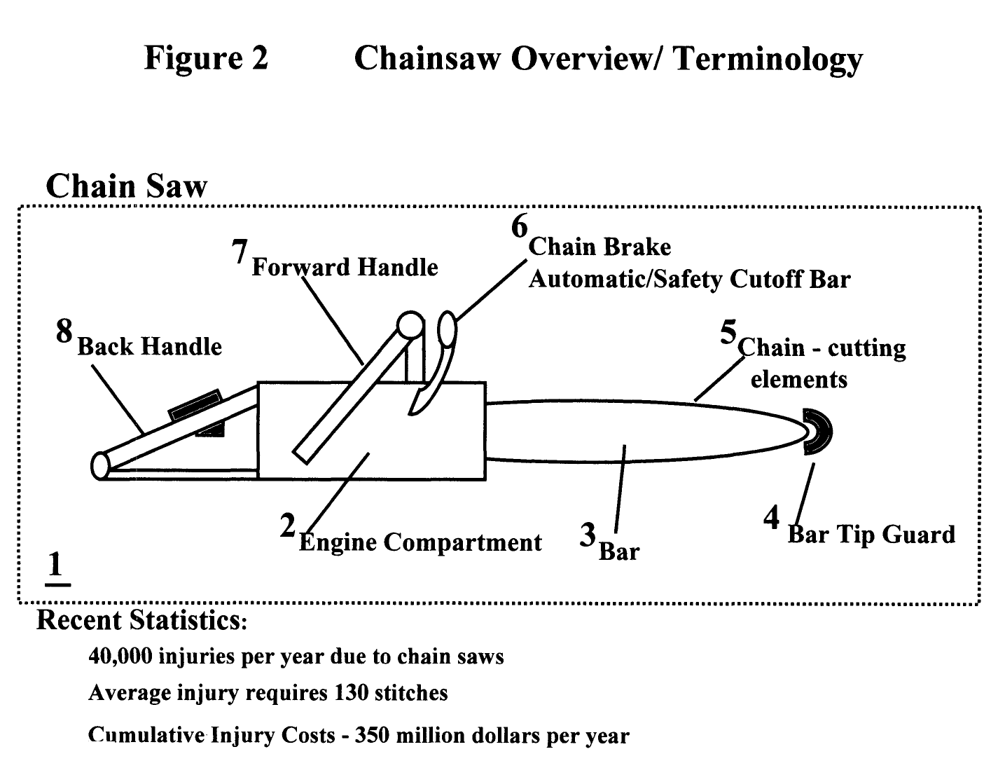

FIG. 2 shows diagrammatically typical chain saw 1 components: namely, a forward handle 7 and back handle 8 for enabling a user to grip or hold the saw, an engine compartment 2 holding a motor (typically a two-cycle gasoline engine) mounted on a bar 3, a bar tip guard 4 on the free end of the bar 3, endless-chain mounted cutting elements 5, and a chain-brake automatic/safety cutoff lever 6. These components are a representative set and not to be interpreted as all—inclusive listing. The bar tip guard 4 is a safety mechanism attached to chain saw bar 3 to prevent the teeth on the endless chain circumventing the tip, from coming into contact with any external object. The tip of the chain saw in some circumstances causes kick back.

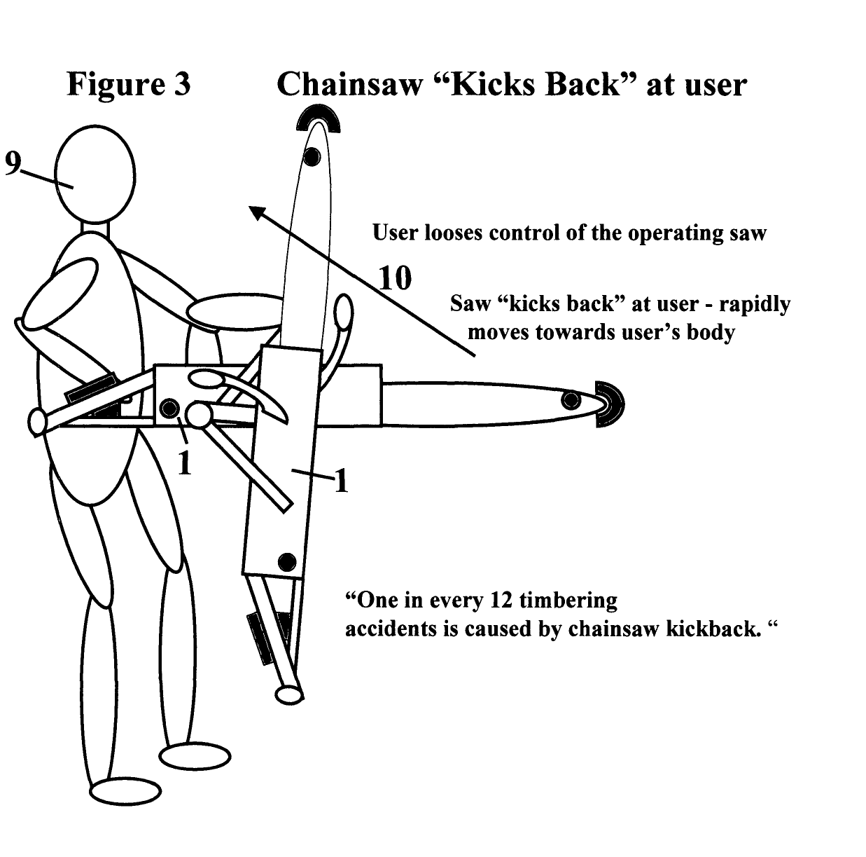

Kick back, reflected in FIG. 3 by the vertically-disposed chain saw 1, is a rapid movement 10 of the free end of chain saw 1 up towards the unknowing operator 9.

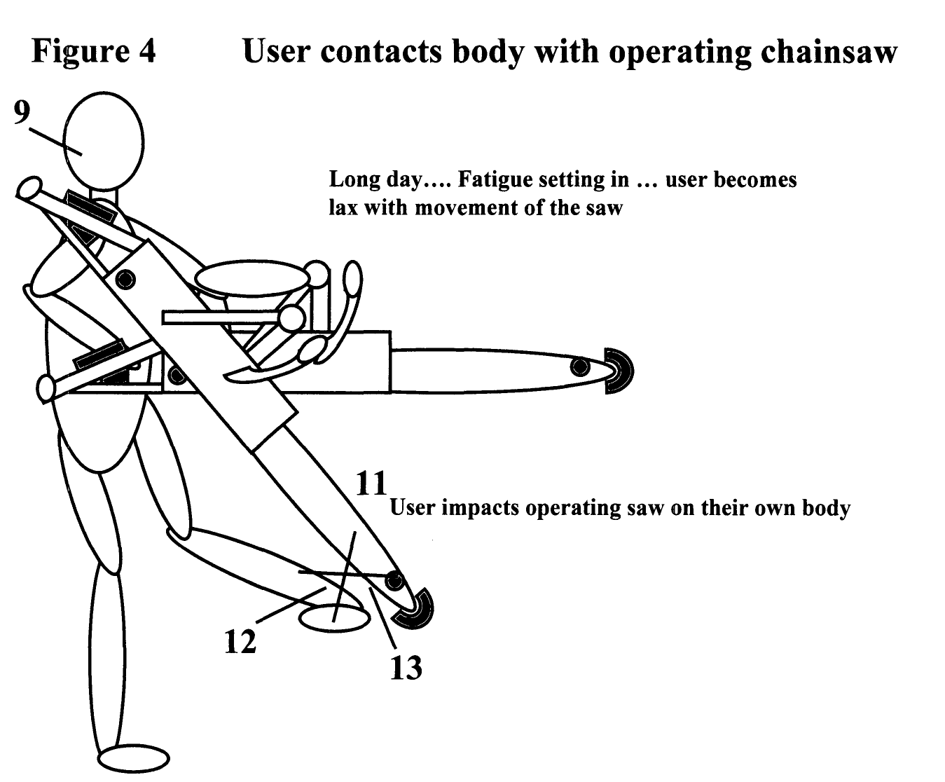

FIG. 4 shows an accident that may occur on any of a number of possible scenarios. Logging is a very physically demanding occupation in which fatigue plays a very critical role. Thus a tired logger 9 may allow the chain saw free end 13 to drop accidentally and come into contact with the lower portion 12 (leg and/or foot) of the his body.

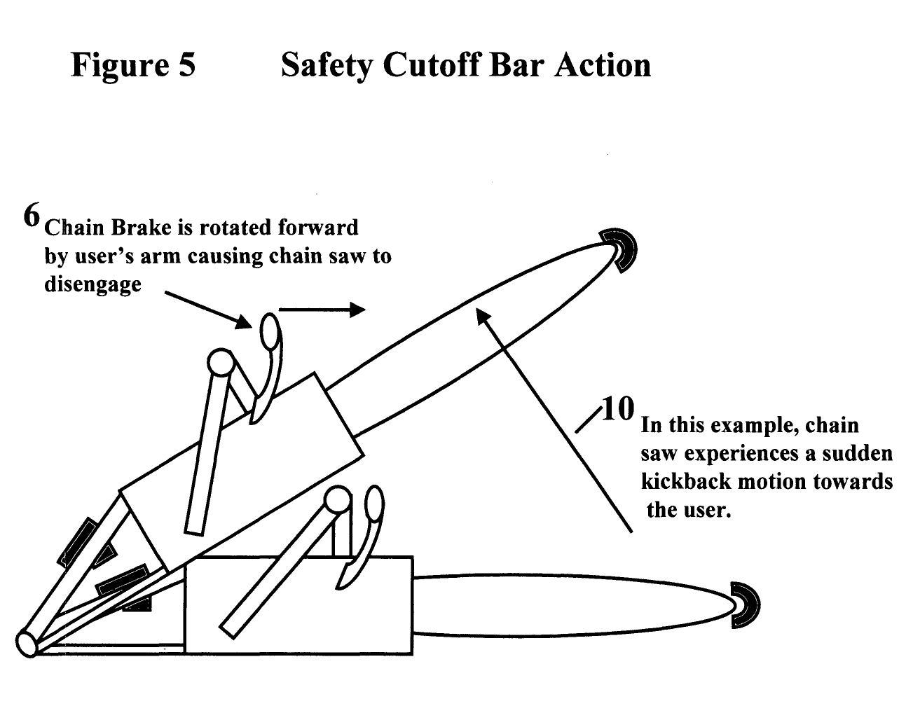

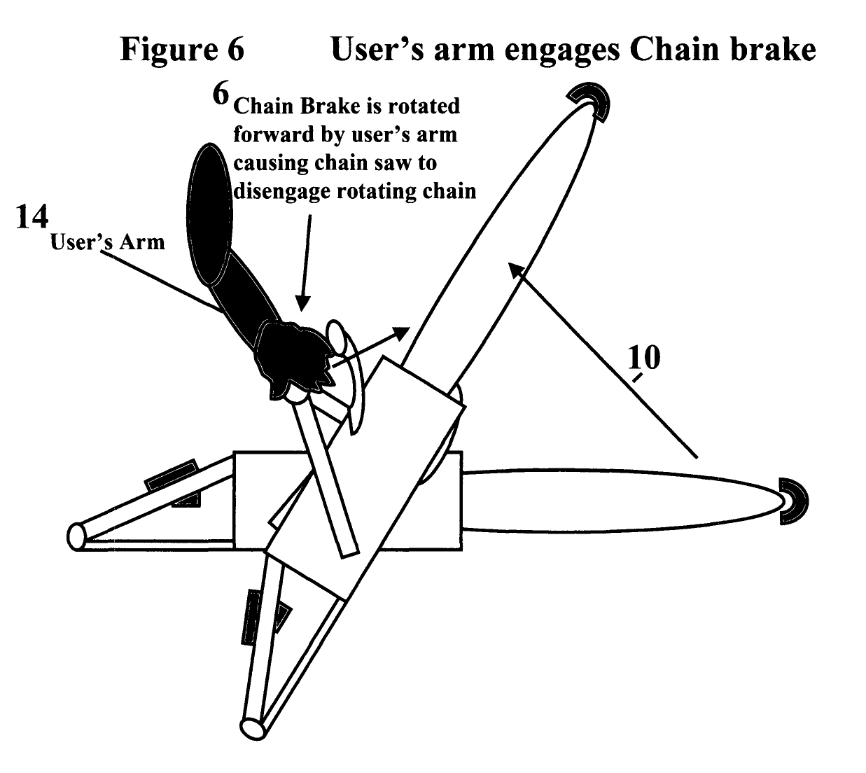

Kick back 10, depicted in an early stage in FIG. 5, typically causes upon further motion the belated engagement of the chain brake lever 6 by the operator's arm portion of his body 14, resulting in the relative forward motion of the chain brake lever 6 as shown in FIG. 6. When the chain brake lever is moved forward, the operation of the motor is interrupted. Thus should the inertia of the kicked back saw continue to carry the saw into contact with the user, injury due to revolution of the toothed endless chain will be reduced. Unfortunately, revolution of the endless chain 5 is not always halted before the chain saw contacts the user on kick back, due to the belated contact of the user's arm 14 with the brake lever 6.

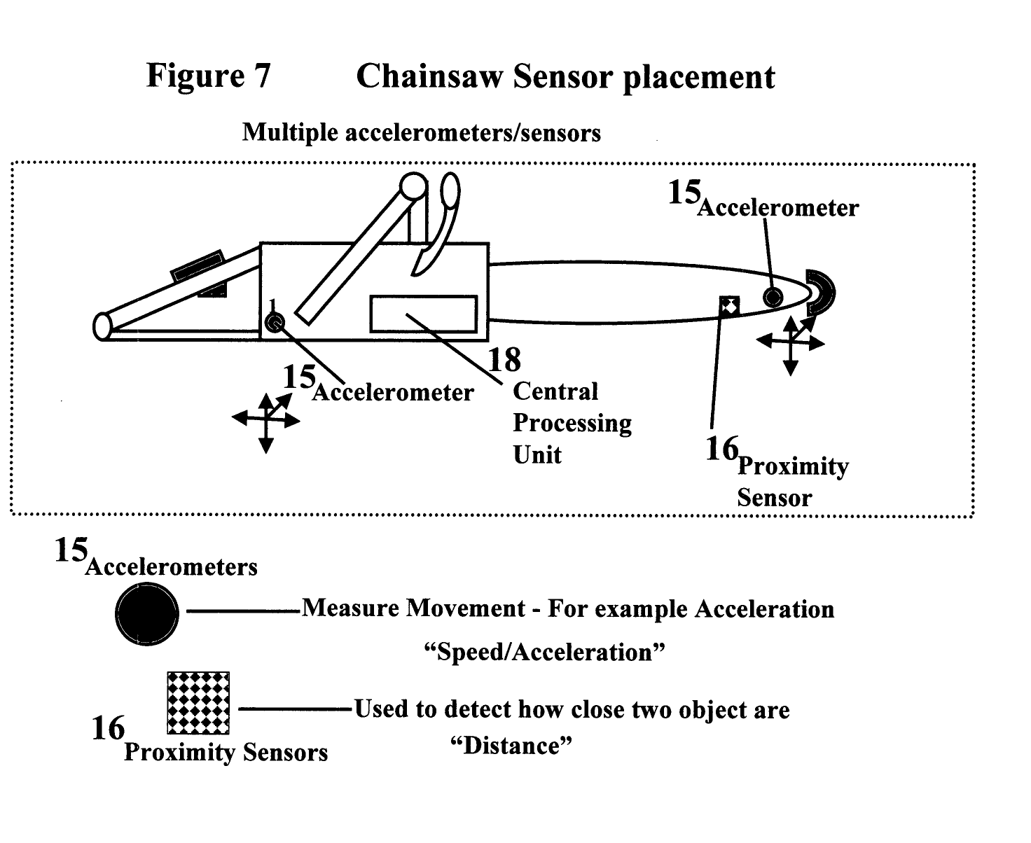

This invention effects earlier sensing of chain saw kick back action and earlier actuation of the brake lever 6, by mounting one or more accelerometers on or in the bar 3. Accelerometers are sensors that detect and measure movement (velocity and/or acceleration). FIG. 7, shows two of many possible placements on a chainsaw of accelerometers 15 with a corresponding central processing unit (CPU) 18. On kick back, the accelerometer 15 on the free end of the bar would undoubtedly quickly sense the abrupt upward angular movement of the free end of the bar and send signals to the central processing unit 18 which in turn would send signals to an electromechanical device such as a solenoid which would move the brake lever 6 forward to turn off the chain saw motor. Thus earlier actuation of the brake lever 6 is effected on kick back action of the chain saw, resulting in revolution of the endless chain 5 being halted before the chain saw contacts the user and cuts him.

Also shown in FIG. 7 where the central processing unit 18 and the electro-mechanical device move the brake lever 6 forward to turn off the chain saw motor, other aspects of the invention are also used to stop the cutting action of the chain saw in the event that the saw the cutting arm gets within predetermined hazardous distances from body parts of the user. To this end, a proximity sensor 16 is mounted near the free or front end of the endless-chain encircled portions of the chain-saw bar, to very quickly and accurately determine the distance of the cutting chain from any physical part of the user wearing a proximity sensor (resident sensor or emitter). As the saw proximity sensor 16 gets within a predetermined hazardous distance off a body-resident sensor, it emits signals to discontinue movement of the cutting endless chain. The signal processor 18 mounted on the chain saw receives the proximity signals of hazardous closeness(s) and signals an electromechanical device to apply the proper electrical and/or mechanical measures to discontinue movement of the cutting endless chain. Discontinuance of the cutting endless-chain movement may be by electrical circuit opening, de-clutching and/or braking operations.

It is important to place the proximity sensor close to the cutting surface from which the distance to the operator is to be measured. The CPU would perform the necessary real-time signal processing activities.

As evident, proximity sensors enable one to determine how close one object is to another. They, like accelerometers, are readily available. Proximity sensors come in many shapes, sizes, footprints, and functionality. There are many ways in which this distance measurement can be made, from capacitance to optical means.

The chain saw bar-mounted accelerometers and proximity sensors must be of such size and shape as not to interfere with the operation of the chainsaw itself. The width of the accelerometer or the proximity sensor and the bar or arm must be less than the width of the endless chain cutting elements themselves. The accelerometer and proximity sensors must also be integrated with the bar or arm in such a way so that they do not get hung up on the object being cut. There must be a smooth transition from arm to the top edge of accelerometer or sensor and back down to the arm surface. If a sensor is physically (i.e. instead of wireless) connected to the processor, any wiring must of course, be protected (enclosed).

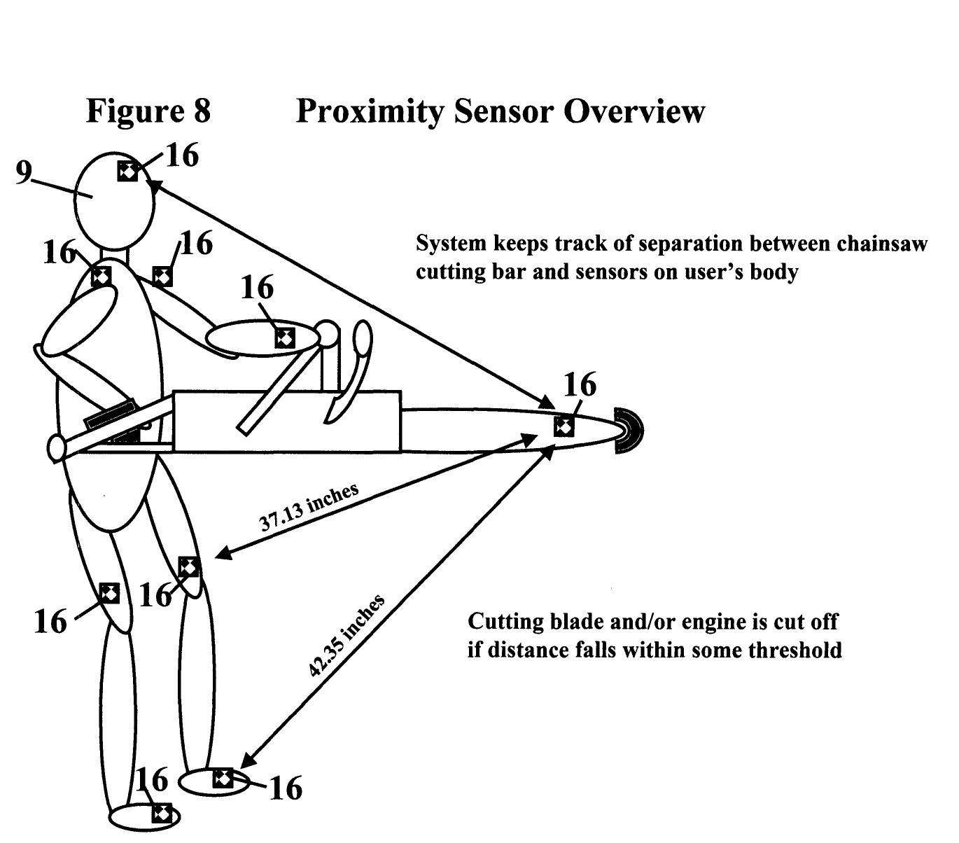

FIG. 8 depicts another embodiment of a chain-saw safety system using proximity sensors 16. The proximity sensor on the chainsaw bar itself is located near its free end and is wherefrom the distance measurements are made to the proximity sensors 16 resident on the forward or seriously-exposed portions of the operator's body 9. Optimally, there would exist a proximity sensor array great enough to protect all possible areas of potential chainsaw contact. Interruption of chainsaw operation would be effected in the event that any of these continuously monitored distance measurements fell below predetermined thresholds which may be different for the proximity sensors 16 on the various body locations.

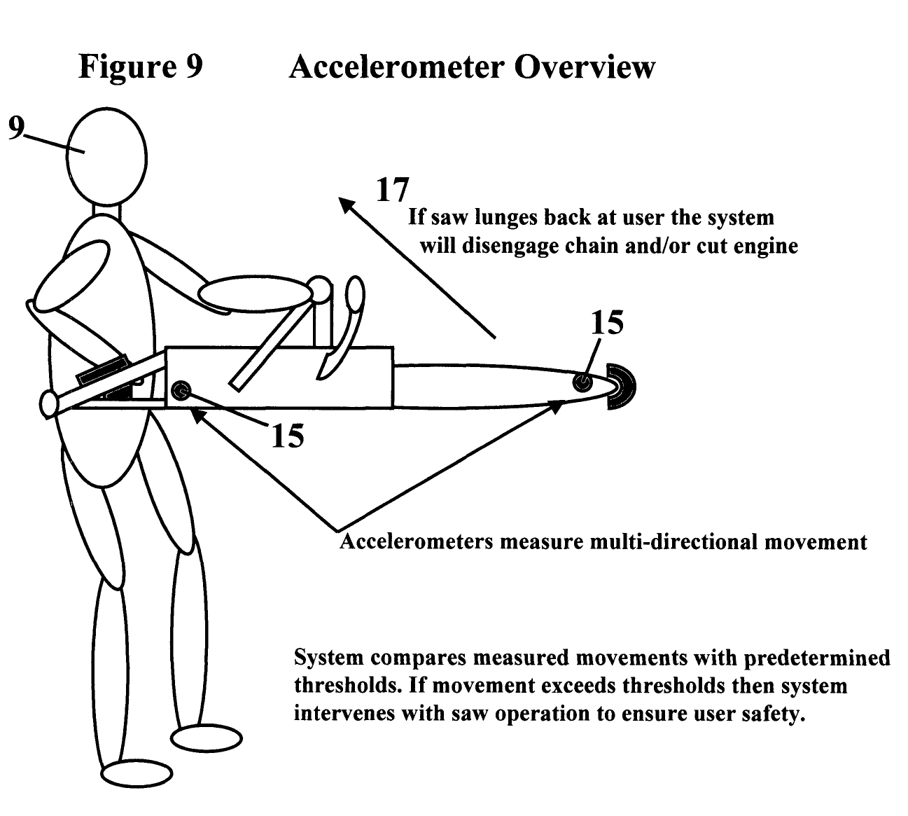

FIG. 9 depicts an embodiment of a chain-saw safety system using two accelerometers, to handle another scenario. In this scenario, the chainsaw is suggested at 17 as moving towards the operator 9; its motion is being measured by the two chain-saw resident accelerometers 15. If the rate of velocity change exceeds the predetermined threshold for either accelerometer, the chain saw operation is interrupted.

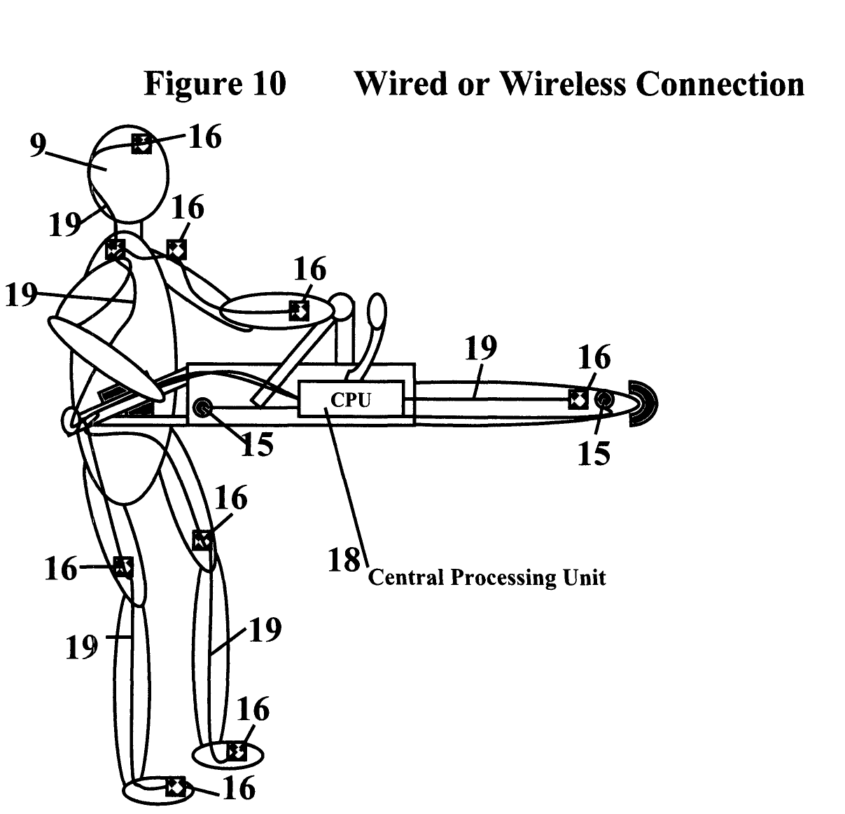

FIG. 10 diagrammatically depicts the accelerometers 15 on the respective ends of the chain saw bar and a proximity sensor 16 on the free end of the bar, and number of proximity sensors 16 on the forward portions of the user's body 9, all being connected to the CPU 18 on the chain saw by means of “wired” connections. A wireless-connected array of sensors is an alternative, or could be used in conjunction with wired sensors.

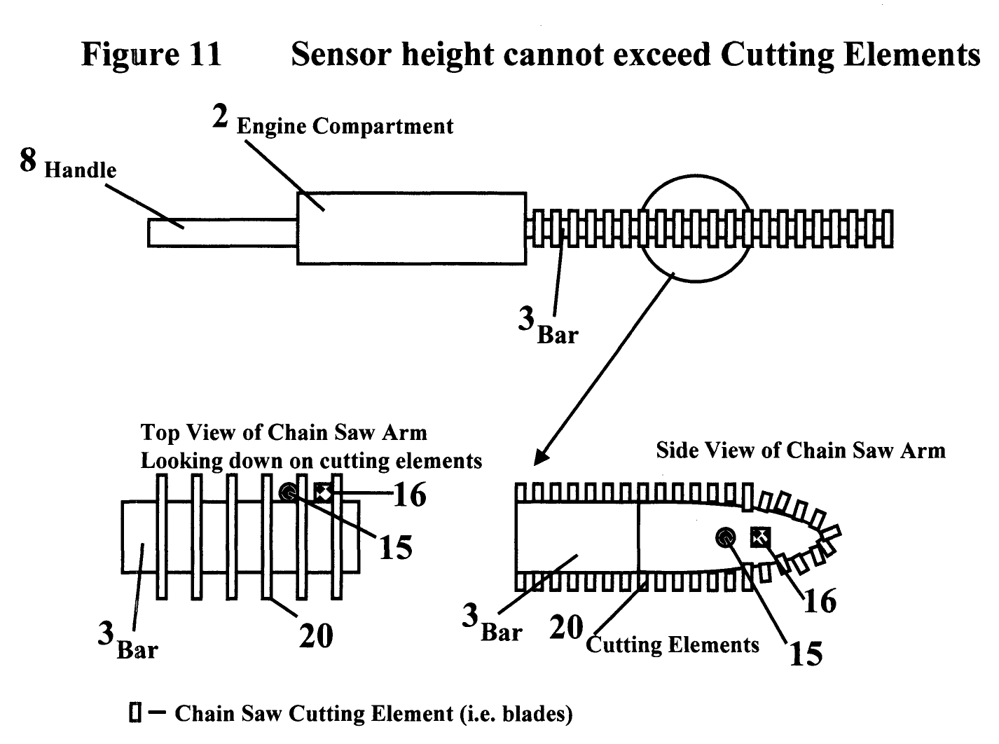

Several views of the chainsaw cutting elements 20 relationships to the chainsaw, are shown in FIG. 11. Accelerometer and proximity sensors 15 and 16 placed on or within the chain saw bar, do not interfere with the standard operation of the unit. The, sensors 15 and 16 do not protrude from the side of the bar 3 with a width such that they might get hung up on the material being cut.

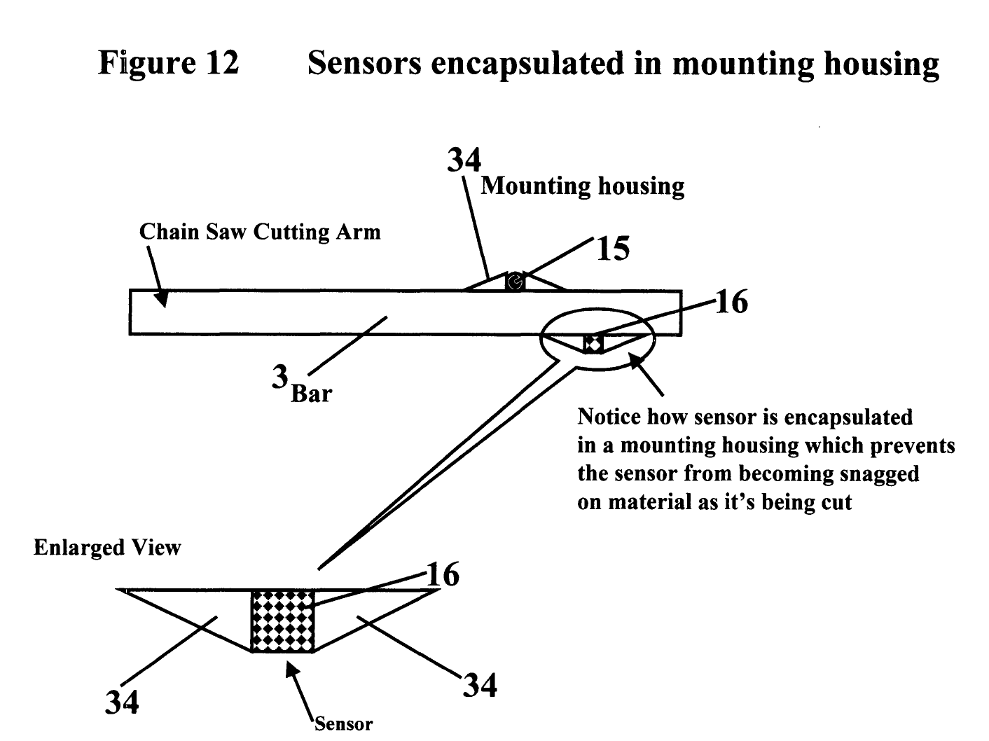

FIG. 12, depicts encapsulation of the sensors 15 and 16 in an encasement 34 which provides inclined slopes protecting the sensors 15 and 16 in a graduated expansion of the bar 3 surface. The mounting housing 34 secures the sensors 15 and 16 to the bar 3, and provides such a graduated width change.

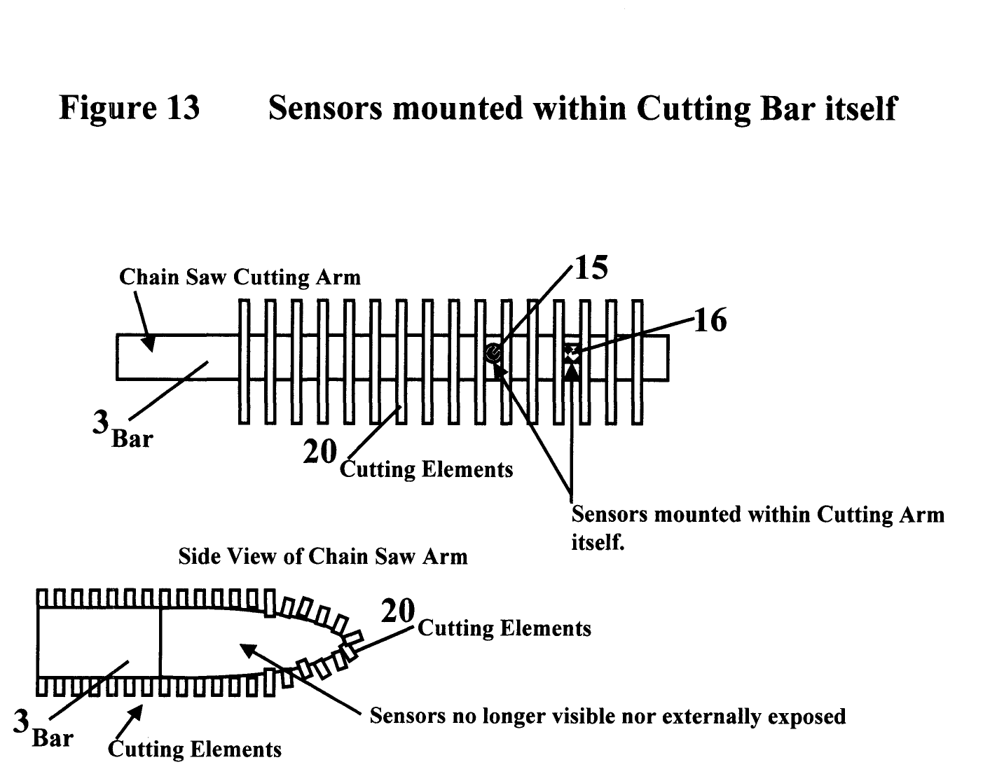

In FIG. 13, sensors 15 and 16 are shown mounted within the bar 3 itself, care being taken not to interrupt the signal transmission from and detection paths to the proximity sensors 16 as by covering them with a wave permeable material.

As noted above, with proximity sensors 16 a distance measurement is made between two sensors. Should some sort of object come into place between the pair of sensors, the measurement might possibly be incorrect. If an object interrupts a measurement, the CPU checks the measurements of the other sensors of the array to intelligently determine the chainsaw proximity and dynamics. Thus the proximity sensor measurements are interpreted independently as well as interdependently.

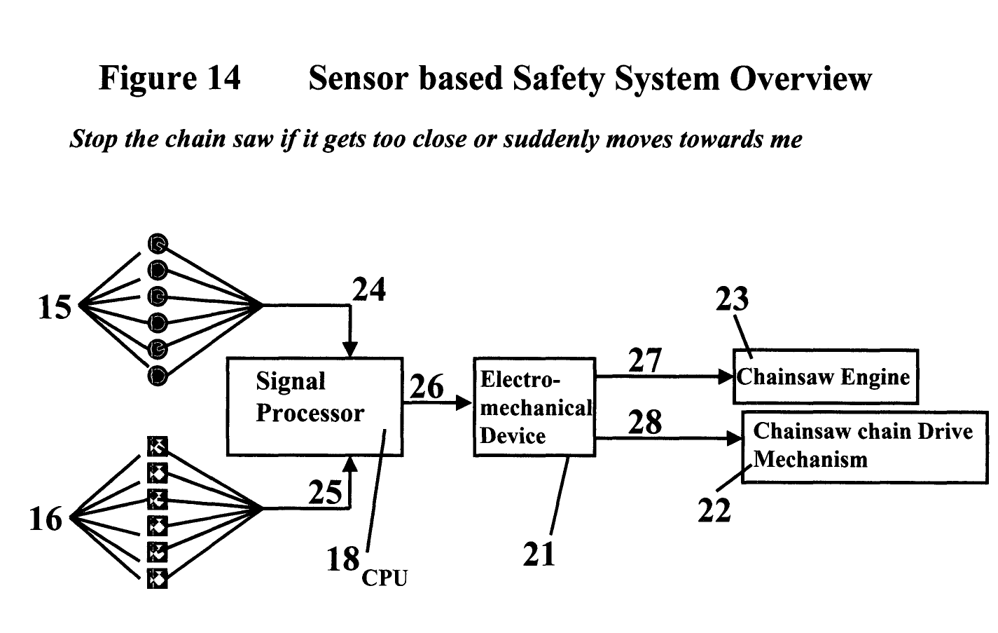

FIG. 14 provides the reader with an overview of the invention. The system may consist of an array of accelerometers 15 with output signal paths 24, proximity sensors 16 with output signal paths 25, a signal processor/central processing unit 18, an electro-mechanical device 21 which connects to the chain saw engine 23 via signal 27 and the chain saw drive mechanism 22 via signal 28. The electromechanical device acts as the interface to the chain saw itself to invoke the proper interruption of operation should the apparatus detect a dangerous situation. While FIG. 14 shows components at a conceptual level, the actual physical hardware arrangement may vary, especially since technology often incorporates or integrates much functionality within single integrated-circuitry (IC) chips.

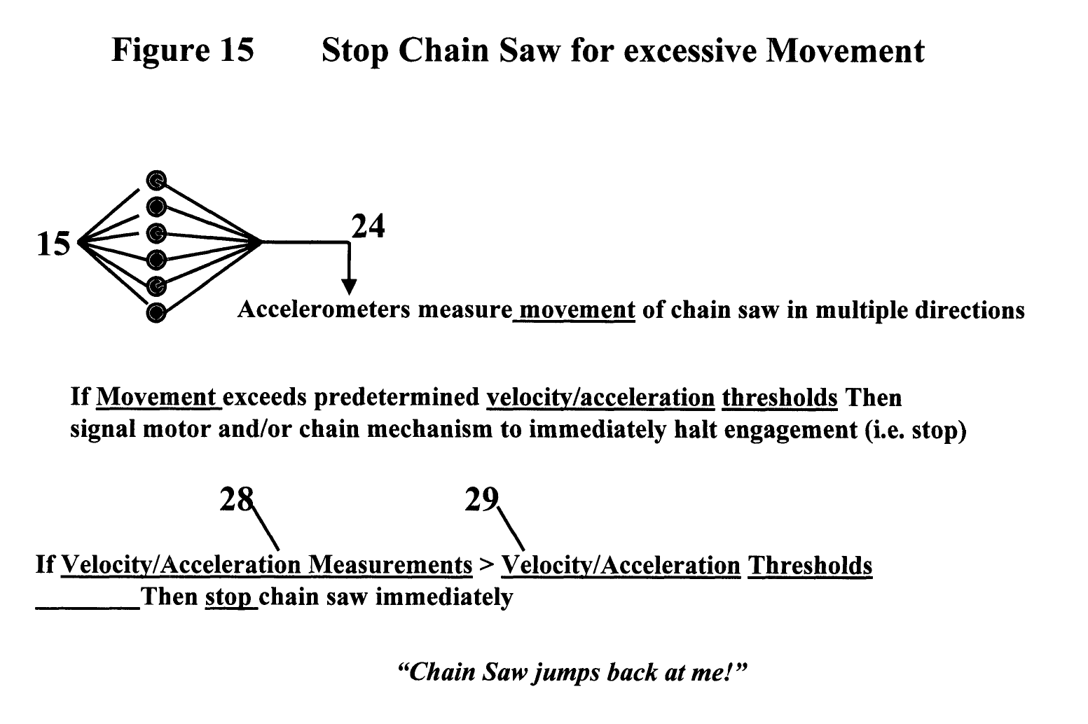

FIG. 15 depicts a simple mathematical operation using the accelerometer 15 measurements 24. If the amount of movement 28 determined by accelerometer 15 and indicated by measurement 24 exceeds a predetermined threshold 29, the chain saw operation is interrupted.

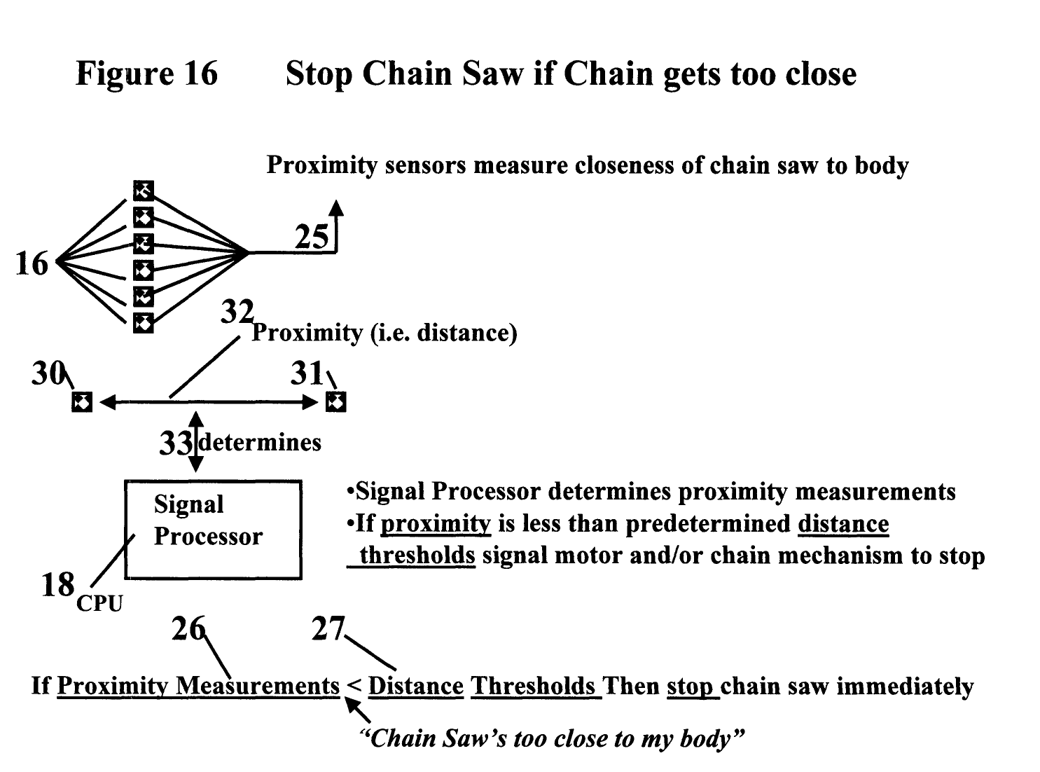

FIG. 16 depicts the mathematical operations for the proximity measurements 25. A distance 32 is determined by measurement of the distance between a pair of sensors 30 and 31. The CPU takes this raw distance measurement and determines 33 the cleaned proximity measurement 26 to which it compares a predetermined threshold 27. If the measurement falls within the threshold 27, it indicates to the CPU that the chain saw is too close to the operator and it signals an interruption of chain saw operation. Hardware as well as software solutions that implement these algorithms are commonly available. The adaptive signal processing algorithms used for sensor array processing and thresholding are well documented. Signal extraction and processing is old, and the associated mathematical algorithms are well documented and used in quite a few products in industry.

In Today's Technology:

Multidimensional signal extraction and processing algorithms exist

Sensors exist;

Processor speeds are sufficient, particularly if the algorithm is simple as in measurement and threshold operations; dedicated devices could be used if very complex algorithms are needed in particular situations. And processor speeds are ever increasing.

With the accelerometer- and proximity-sensor technology, there has been provided a safer chain saw system which is reliable and inexpensive and does not require custom hardware and be too big to sell commercially.

While applicants have shown and described preferred embodiments of the invention, it will be apparent to those skilled in the art that other and different applications may be made of the principles of the invention. It is desired therefore to be limited only by the scope or spirit of the appended claims.

What is claimed is:

1. A safer power-driven cutting machine, comprising a bar, a motor mounted on said bar, a movable cutting apparatus mounted on said bar and driven by said motor, and safety apparatus for controlling movement of said cutting apparatus upon it sensing a certain change in the disposition of the bar.

2. A safer power-driven cutting machine according to claim 1, wherein the safety apparatus for controlling movement of said cutting apparatus upon sensing a certain change in the disposition of the bar also senses another change in the disposition of the bar.

3. A safer power-driven cutting machine according to claim 1, wherein the safety apparatus for controlling movement of said cutting apparatus upon a certain change in the disposition of the bar does so by turning off the motor

4. A safer power-driven cutting machine according to claim 1, wherein the safety apparatus for controlling movement of said cutting apparatus upon sensing a certain change in the disposition of the bar does so by causing the cutting apparatus to stop.

5. A safer power-driven cutting machine according to claim 1, wherein the certain change in the disposition of the bar which the safety apparatus for controlling movement of said cutting apparatus senses is an abrupt movement of the bar.

6. A safer power-driven cutting machine according to claim 5, wherein the safety apparatus for controlling movement of said cutting apparatus upon an abrupt movement of the bar includes an accelerometer.

7. A safer power-driven cutting machine according to claim 6, wherein said accelerometer is near one end of the bar, and the safety apparatus for controlling movement of said cutting apparatus upon an abrupt movement of the bar includes a second accelerometer.

8. A safer power-driven cutting machine according to claim 1, wherein the certain change in the disposition of the bar which the safety apparatus for controlling movement of said cutting apparatus senses is a change in the relationship of the bar to a user thereof.

9. A safer power-driven cutting machine according to claim 8, wherein the certain change in the relationship of the bar to a user thereof is the bar moving within a predetermined hazardous distance of a body part of the user.

10. A safer power-driven cutting machine according to claim 9, wherein safety apparatus for controlling movement of said cutting apparatus upon the bar moving within a predetermined hazardous distance of a body part of the user includes a proximity sensor.

11. A safer power-driven cutting machine according to claim 10, wherein the proximity sensor is mounted on the bar.

12. A safer power-driven cutting machine according to claim 11, wherein the proximity sensor mounted on the bar is mounted on the free end of the bar.

13. A safer power-driven cutting machine according to claim 11, wherein a proximity sensor is also mounted on the user.

14. A safer power-driven cutting machine according to claim 12, wherein a proximity sensor is also mounted on the user.

15. A safer power-driven cutting machine according to claim 14, wherein proximity sensors are mounted on forward exposed body portions of the user.

16. A safer power-driven cutting machine according to claim 5, wherein the safety apparatus for controlling movement of said cutting apparatus upon an abrupt movement of the bar also includes a central processing unit receiving signals from the accelerometer and processing them to control the movement of said cutting apparatus.

17. A safer power-driven cutting machine according to claim 11, wherein the safety apparatus for controlling movement of said cutting apparatus upon the bar moving within a predetermined hazardous distance of a body part of the user also includes a central processing unit receiving signals from the proximity sensor mounted on the bar and processing them to control the movement of said cutting apparatus.

18. A safer power-driven cutting machine according to claim 6, wherein another certain change in the relationship of the bar to a user thereof is the bar moving within a predetermined hazardous distance of a body part of the user, wherein safety apparatus for controlling movement of said cutting apparatus upon the bar moving within a predetermined hazardous distance of a body part of the user includes a proximity sensor, wherein the proximity sensor mounted on the bar is mounted on the free end of the bar, and wherein a proximity sensor is also mounted on the user.

19. A method of operating a safer power-driven cutting machine having a bar, a motor mounted on said bar, and a movable cutting apparatus mounted on said bar and driven by said motor; comprising the steps of turning on said motor to drive the cutting apparatus, and automatically controlling the movement of said cutting apparatus by sensing a certain change in the disposition of the bar.

20. A method of operating a safer power-driven cutting machine having a bar, a motor mounted on said bar, and a movable cutting apparatus mounted on said bar and driven by said motor according to claim 19, wherein movement of said cutting apparatus is automatically controlled in response to sensing an abrupt movement of the bar.

21. A method of operating a safer power-driven cutting machine having a bar, a motor mounted on said bar, and a movable cutting apparatus mounted on said bar and driven by said motor according to claim 19, wherein movement of said cutting apparatus is automatically controlled in response to the bar being sensed as having moved within a predetermined hazardous distance of a body part of the user.

22. A method of operating a safer power-driven cutting machine having a bar, a motor mounted on said bar, and a movable cutting apparatus mounted on said bar and driven by said motor according to claim 20, and wherein movement of said cutting apparatus is also controlled in response to the bar being sensed as having moved within a predetermined hazardous distance of a body part of the user.

23. A safer power-driven cutting machine according to claim 15, wherein the proximity sensor measurements are interpreted independently as well as interdependently.

23. A proximity measurement safety system having a cutting device and a power and/or drive mechanism for the cutting device; comprising a pair of proximity sensors for detecting distance measurements; an electromechanical interface with the power and/or drive mechanism of the cutting device; and a signal processor receiving input from the proximity sensors, processing and validating said signals, determining distance measurement, comparing the distance measurement to preset thresholds, and providing output to the cutting device by way of the electromechanical interface.

24. A proximity measurement safety system having a cutting device and a power and/or drive mechanism for the cutting device according to claim 24, wherein the sensor pair is one pair of a set of sensors used to effectuate measurement over multiple physical areas.

25. An accelerometer measurement safety system having a cutting device and a power and/or drive mechanism for the cutting device; comprising a motion sensor for detecting movement in multiple directions; an electromechanical interface with the power and/or drive mechanism of the cutting device; and a signal processor receiving input from the notion sensor, processing and validating said signal, determining motion measurements over multiple axis, comparing the measurements to preset thresholds, and providing output to the cutting device by way of the electromechanical interface.

26. A motion measurement safety system having a cutting device and a power and/or drive mechanism for the cutting device according to claim 26, wherein the sensor is one of a set of sensors used to effectuate measurement over multiple physical areas.

27. A motion and proximity safety system having a cutting device and a power and/or drive mechanism for the cutting device according to claim 24; and a motion sensor for detecting movement in multiple directions; said signal processor also receiving input from the motion sensor, processing and validating the signal, determining motion measurements over multiple axis, comparing the measurements to preset thresholds, and providing output accordingly to the cutting device by way of the electromechanical interface to provide for increased accuracy and safety.

28. A motion and proximity measurement safety system having a cutting device and a power and/or drive mechanism for the cutting device according to claim 28, wherein the cutting device has a cutting arm, wherein sensors are mounted within the cutting arm while still exposing the sensing portion of the sensors to reduce the vulnerability of the sensors to dislodgment and the device operation to obstruction.

29. A motion and proximity measurement safety system having a cutting device and a power and/or drive mechanism for the cutting device according to claim 28, wherein the cutting device has a cutting arm, wherein sensors are mounted within a graduated edge housing on the arm while still exposing the sensing portion of said sensor to reduce the vulnerability of the sensor to dislodgment and the device operation to obstruction.
